(19) United States
(12) Patent Application Publication
(10) Pub. No.: US 2016/0115714 A1
(43) Pub. Date: Apr. 28, 2016

(54) LOCK ASSEMBLY STRUCTURE

(71) Applicant: Taiwan Puritic Corp., Hukou Township (TW)

(72) Inventor: Long-Jia PAN, Hukou Township (TW)

(21) Appl. No.: 14/824,496

(22) Filed: Aug. 12, 2015

(30) Foreign Application Priority Data
Oct. 24, 2014 (TW) 103218928

(51) Int. Cl. E05B 51/02; E05B 15/00

(52) U.S. Cl. CPC E05B 51/02; E05B 15/00

(57) ABSTRACT

A lock assembly structure includes a lock base, an actuating component, a locking component and a lock sheet. By using the actuating component to drive the locking component to be moved with respect to the lock base and the lock sheet movable with respect to the lock base, the lock sheet may be ensured to be maintained in the closed position or be out of the closed position. Wherein, the actuating component is a hydraulic or pneumatic actuating component, thereby the sparks that may be generated by the motor actuator during operation may be avoided. The lock assembly structure further includes a blocker sheet, which is movable with respect to the lock base. When the actuating component is functioned improperly, the lock sheet may also be ensured to be maintained in the closed position or be out of the closed position by changing the position of the blocker sheet.

### BACKGROUND OF THE INVENTION

1. Field of the Invention

The present invention relates to a lock assembly structure, and particularly to a lock assembly structure used for a valve manifold box or a gas cabinet.

2. Description of the Prior Art

For the articles valued by people or some security considerations, various lock assembly structures are proposed to achieve specific protection effects. Moreover, based on modern management, the traditional lock assembly must be added with functions of electrical sensing and recording, so as to control the unlocking and locking of the lock assembly and record the related use conditions of the lock assembly.

At present, many lock assemblies are activated through elements such as the electrical motor actuator, sensor, and controller, etc. However, for the lock assembly of the valve manifold box used to manage pipes of special gases such as combustible, flammable or combustion-supporting gases, or for the electronic lock assembly that may be exposed to an environment containing those special gases, the lock assembly that employs a motor actuator may generate sparks more easily during operation, so that the risks of causing a gas explosion or a fire may be increased. In addition, a portion of the existing devices have protection designs to avoid the leakage of the sparks generated by the motor actuator. However, the protection designs have a problem of occupying a larger volume, and also have a problem of a higher cost due to the strict demands of the scale specification of the related protection designs. Moreover, when these electronic lock assemblies have malfunctions, it is tended to cause the lock assemblies fail wholly, and the lock assemblies could not be unlocked or locked.

### SUMMARY OF THE INVENTION

In order to improve the drawbacks of the prior art, the present invention proposes a lock assembly structure, which achieves the effect of an electronic lock assembly with a hydraulic or pneumatic actuating component, thereby the sparks that may be generated by the motor actuator during operation may be avoided, and the problems of safety, a larger volume and a higher cost of the motor actuator in use may be solved.

According to one embodiment of the present invention, a lock assembly structure comprises a lock base, an actuating component, a locking component and a lock sheet. The actuating component is hydraulically or pneumatically driven and has a fixing piece and a moving piece. The fixing piece is secured to the lock base, and the moving piece is movably connected to the fixing piece, such that the moving piece may be moved with respect to the lock base and has a first moving position and a second moving position. The locking component is movably connected to the lock base, and when the moving piece is moved between the first moving position and the second moving position, the locking component is movably connected to the moving piece. The lock sheet is movably connected to the lock base and has a blocker sheet. The lock sheet may be moved to a closed position and an open position with respect to the lock base. In addition, when the lock sheet is in the closed position and the moving piece is in the first moving position with respect to the lock base, the locking component is interfered with the blocker sheet if the lock sheet is intended to be moved away from the closed position with respect to the lock base, thereby a motion of the lock sheet with respect to the lock base is constrained. In addition, when the lock sheet is in the closed position and the moving piece is in the second moving position with respect to the lock base, the blocker sheet is detachable from the locking component if the lock sheet is intended to be moved away from the closed position with respect to the lock base, such that the lock sheet may be moved to the open position.

Preferably, the fixing piece and the moving piece of the actuating component are a cylinder and a piston rod respectively, and the moving piece is slidably connected to the fixing piece.

Preferably, the lock sheet comprises a blocker sheet. The blocker sheet is movably connected to the lock sheet and may be moved to a preset position and an unlocked position with respect to the lock sheet. In addition, when the lock sheet and the blocker sheet are in the closed position and the preset position respectively and the moving piece is in the first moving position with respect to the lock base, the tongue piece locking portion is interfered with the blocker sheet if the lock sheet is intended to be moved away from the closed position with respect to the lock base, thereby a motion of the lock sheet with respect to the lock base is constrained. In addition, when the blocker sheet is in the unlocked position, the lock sheet may be out of the closed position. With the above-mentioned configurations, the blocker sheet may be operated to the unlocked position, so that the lock sheet may be out of the closed condition at any time, regardless the actuating component is functioned properly or not.

Preferably, the blocker sheet may be further moved to a locked position with respect to the lock sheet. The preset position is positioned between the locked position and the unlocked position. In addition, when the lock sheet and the blocker sheet are in the closed position and the locked position respectively and the moving piece is in the second moving position with respect to the lock base, the tongue piece locking portion is interfered with the blocker sheet if the lock sheet is intended to be moved away from the closed position with respect to the lock base, thereby a motion of the lock sheet with respect to the lock base is constrained. With the above-mentioned configurations, the blocker sheet may be operated to the locked position, so that the lock sheet may be ensured to be in the closed condition, regardless the actuating component is functioned properly or not.

The objectives, subject matters and properties of the present invention and the effects achieved by the present invention will become apparent from the following descriptions of the embodiments taken in conjunction with the accompanying drawings.

### BRIEF DESCRIPTION OF THE DRAWINGS

FIG. 1 is a perspective view showing that a lock sheet of a lock assembly is in a closed position with respect to a lock base according to one embodiment of the present invention;

FIG. 2 is a perspective view showing that the lock sheet of the lock assembly is in an open position with respect to the lock base according to FIG. 1;

FIG. 3 shows an explosive, perspective view of various elements of the lock assembly according to FIG. 1;

FIG. 4A shows a moving piece of an actuating component of the lock assembly in a first moving position and a position relation between a locking component and the actuating component according to FIG. 1;

FIG. 4B shows the moving piece of the actuating component of the lock assembly in a second moving position and the position relation between the locking component and the actuating component according to FIG. 4A;

FIG. 5 shows one example that the locking component is locked with a blocker sheet of the lock sheet and the locking component is not moved with the lock sheet according to FIG. 4A;

FIG. 6A and FIG. 6B show one example that a motion of the lock sheet is constrained by the locking component and the locking component is moved with the lock sheet according to FIG. 4A;

FIG. 7A is one example according to FIG. 4B and continued with FIG. 5, showing a corresponding position relation between the locking component and the blocker sheet of the lock sheet after a change of the position of the locking component;

FIG. 7B shows that the lock sheet may be moved to an open position with respect to the lock base according to FIG. 7A;

FIG. 8A to FIG. 8D are examples according to FIG. 4B and continued with FIG. 6A and FIG. 6B, showing an act view that the lock sheet is moved from the closed position to the open position when the moving piece is in the second moving position, wherein the locking component may be pushed by the lock sheet, such that the blocker sheet is detached from the locking component;

FIG. 9A to FIG. 9C show that the blocker sheet may be moved to an unlocked position, a preset position and a locked position with respect to the lock sheet respectively;

FIG. 10 shows that the lock sheet may be out of the closed position when the blocker sheet is in the unlocked position according to FIG. 4A and FIG. 9A; and

FIG. 11 shows that when the blocker sheet is in the locked position, even if the moving piece is in the second moving position, the lock sheet may be ensured to be maintained in the closed position according to FIG. 4B and FIG. 9C.

### DESCRIPTION OF THE PREFERRED EMBODIMENT

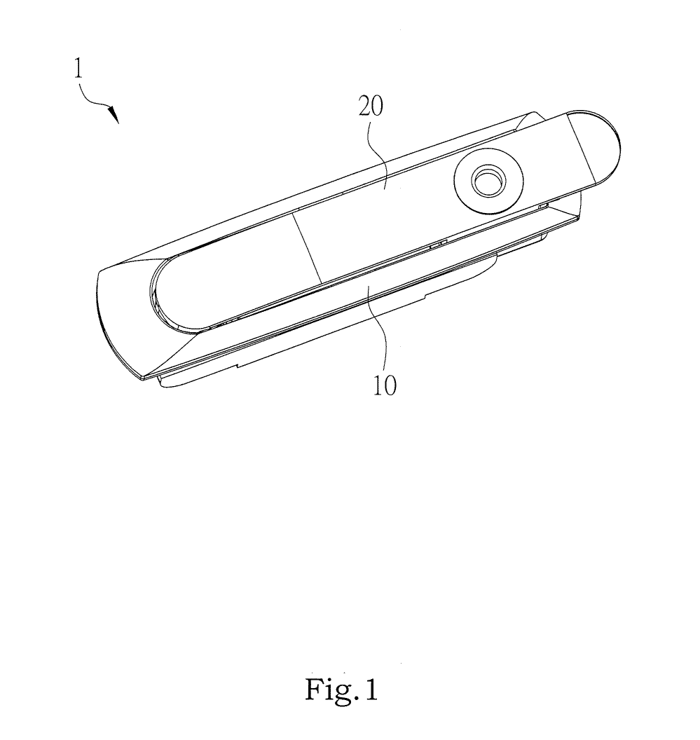

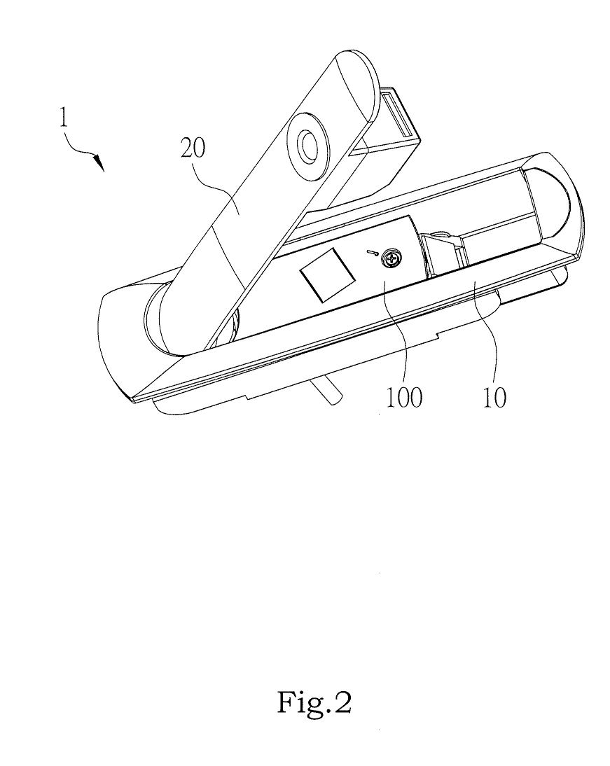

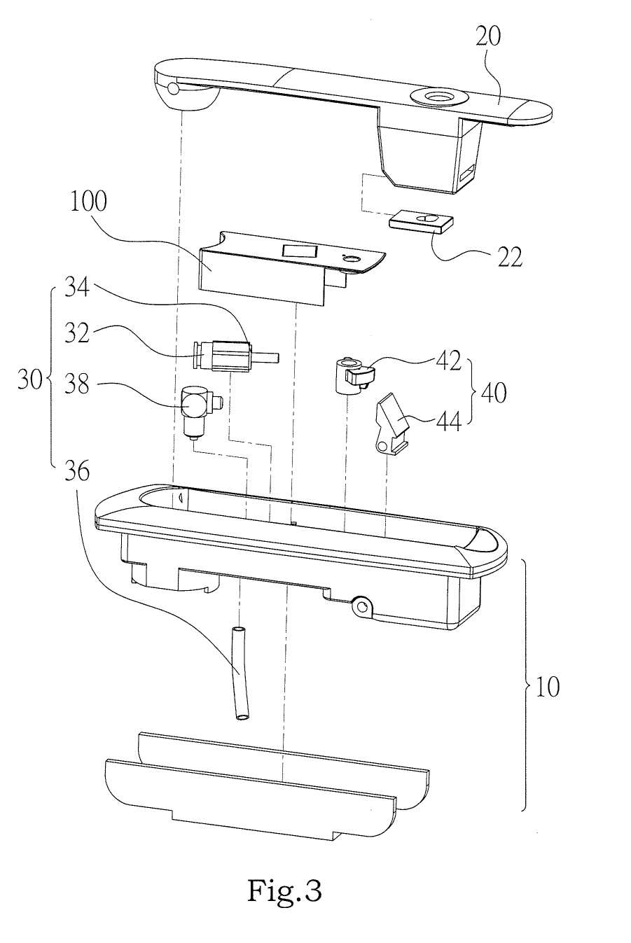

As shown in FIG. 1 and FIG. 2, the use states of a lock assembly 1 of one embodiment of the present invention are shown respectively. The lock assembly 1 has a lock base 10 and a lock sheet 20, and the lock sheet 20 is movably connected to the lock base 10, such that the lock sheet 20 may be moved to a closed position and an open position, as shown in FIG. 1 and FIG. 2 respectively, with respect to the lock base 10. In more detail, the lock sheet 20 is constrained in the closed position or moved into the open position through the aid of the connection relation of an actuating component 30 and a locking component 40 contained in a cover plate 100 (as shown in FIG. 3). It should be noted that, in this example, the lock sheet 20 is connected to the lock base 10 through a rotary joint, but other connection manner that does not use a rotary joint is not limited. Also, it should be noted that the cover plate 100 has the effect of protecting the actuating component 30 and the locking component 40, and is detachably secured to the lock base 10. Thus, when the cover plate 100 is secured to the lock base 10, the cover plate 100 may be regarded as a portion of the lock base 10, i.e., integrated with the lock base 10. However, in another feasible embodiment, the lock base 10 may not have the cover plate 100.

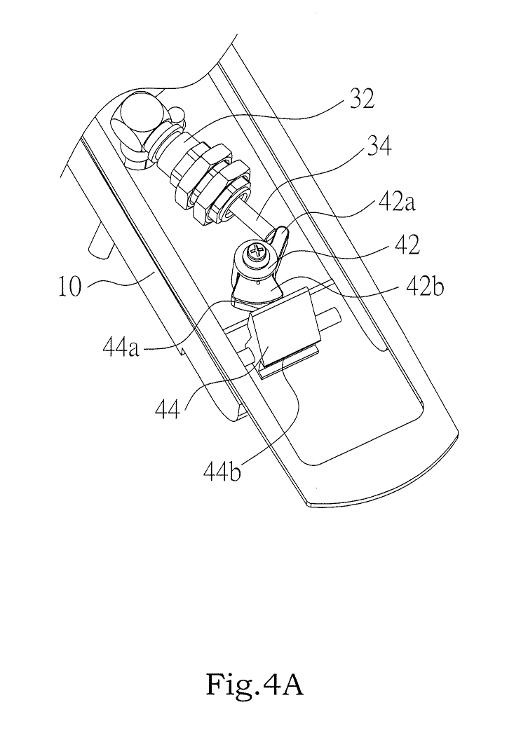

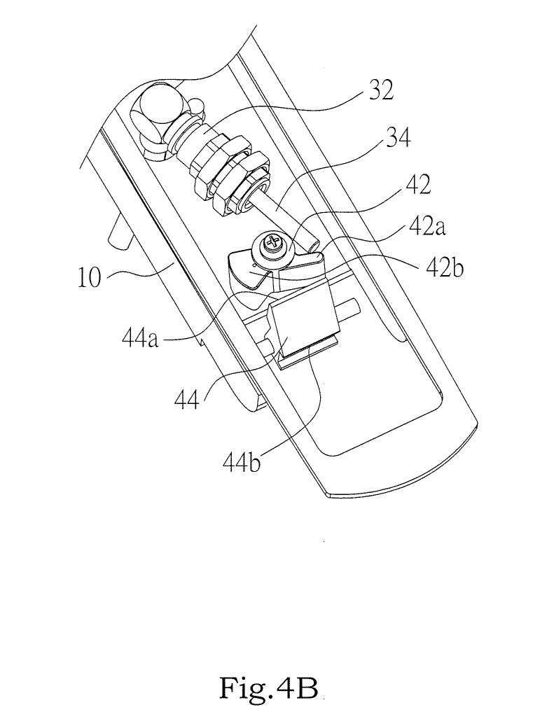

As shown in FIG. 3, an explosive, perspective view of the lock assembly 1 according to one embodiment in FIG. 1 is shown. The lock base 10 may be composed of more than one element, and the lock sheet 20 has a blocker sheet 22. The actuating component 30 comprises a fixing piece 32 and a moving piece 34. The fixing piece 32 is secured to the lock base 10, and the moving piece 34 is movably connected to the fixing piece 32, such that the moving piece 34 may be moved with respect to the lock base 10 and has a first moving position (as shown in FIG. 4A) and a second moving position (as shown in FIG. 4B). Additionally, the moving piece 34 is hydraulically or pneumatically driven by the actuating component 30 to be moved with respect to the fixing piece 32. In more detail, the actuating component 30 further comprises a fluid pipe 36 and a pipe joint 38, and the pipe joint 38 is connected between the fixing piece 32 and the fluid pipe 36. In addition, the actuating component 30 further comprises a valve element (not shown) that may be controlled to be opened or closed and be connected to the fluid pipe 36. By controlling the opening or closing of the valve element, the moving piece 34 may be actuated to be moved with respect to the fixing piece 32. Preferably, the valve element is disposed at one end of the fluid pipe 36, e.g., at the source of the fluid pipe 36. Preferably, the opening and closing of the valve element are controlled through the sensing control of an electronic identification device (for example, a RFID sensor) and a virtual key (for example, a RFID TAG), and the related controlling means is not limited to the above example. Preferably, the valve element is disposed at one side of the lock assembly 1. It should be noted that, the figures of the present invention only illustratively show that the moving piece 34 is a piston rod, the fixing piece 32 is a cylinder, and the moving piece 34 is slidably connected to the fixing piece 32, but the movable connecting manner between the moving piece 34 and the fixing piece 32 is not limited to this.

On the basis of FIG. 3, as further shown in FIG. 4A and FIG. 4B, the moving piece 34 is moved to the first moving position and the second moving position respectively, and the connection and movement relation between the locking component 40 and the moving piece 34 is shown as well. Moreover, according to the examples shown in the figures of the present invention, the locking component 40 comprises an intermediate piece 42 and a tongue piece 44. The intermediate piece 42 is movably connected to the lock base 10, and has a first contacting portion 42a and a second contacting portion 42b. The tongue piece 44 is movably connected to the lock base 10, and has a tongue piece contacting portion 44a and a tongue piece locking portion 44b. When the moving piece 34 is moved to the first moving position, the first contacting portion 42a and the moving piece 34 are movably connected, and with the structural and spatial configurations of the second contacting portion 42b and the tongue piece contacting portion 44a, the tongue piece 44 has a first tongue piece state. When the moving piece 34 is moved to the second moving position, the first contacting portion 42a and the moving piece 34 are movably connected, and with the structural and spatial configurations of the second contacting portion 42b and the tongue piece contacting portion 44a, the tongue piece 44 has a second tongue piece state. In one embodiment, as shown in the illustrative examples shown in the figures of the present invention, the slidable and rotatable connection between the moving piece 34 and the first contacting portion 42a of the intermediate piece 42 is achieved through a cam pair/joint. However, it should be noted that, based on the related knowledge background of the mechanism design, the movable connection between the moving piece 34 and the intermediate piece 42 is not limited to the means of the cam pair/joint.

Also, it should be noted that, in one example (not shown), the locking component 40 only comprises a tongue piece 44, and with the geometric configuration between the actuating component 30 and the tongue piece 44, when the moving piece 34 is moved between the first moving position and the second moving position, the tongue piece 44 has the corresponding first tongue piece state and second tongue piece state. In addition, in this configuration, the composed members of the locking component 40 are minimized, so that the overall costs of production, installation or maintenance of the locking component 40 and the lock assembly 1 are reduced. It should be noted that, in another example (not shown), the locking component 40 comprises an intermediate piece 42 and a tongue piece 44, and the intermediate piece 42 is composed of a plurality of parts (not shown). Preferably, the locking component 40 further comprises at least one first elastic element (not shown). The at least one first elastic element is connected between the locking component 40 and the lock base 10, so that when the moving piece 34 is moved between the first moving position and the second moving position, the first elastic element has a first energy conversion between the potential energy and the kinetic energy, thereby the tongue piece 44 has a tendency, caused by the first elastic element, to be toward a specific motion orientation. In another feasible example, the first elastic element is connected between the intermediate piece 42 and the tongue piece 44.

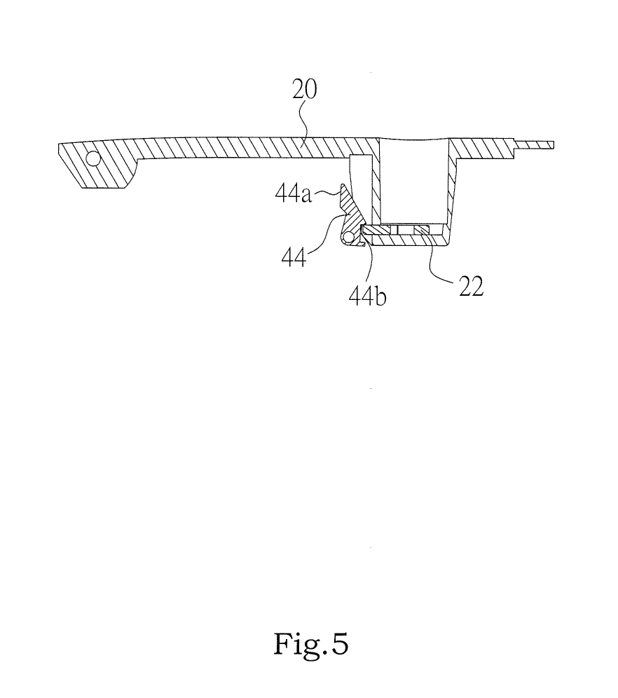

Further referring to FIG. 5, an example that a motion of the lock sheet 20 is constrained by the locking component 40 and the locking component 40 will not be moved with the lock sheet 20 is shown according to FIG. 4A. At this point, the lock sheet 20 is in the closed position (referring to FIG. 1), and the moving piece 34 is in the first moving position with respect to the lock base 10 (as shown in FIG. 4A). The locking component 40 is interfered with the blocker sheet 22 if the lock sheet 20 is intended to be moved away from the closed position with respect to the lock base 10, thereby a motion of the lock sheet 20 with respect to the lock base 10 is constrained. In more detail, as shown in the illustrative example shown in the figure of the present invention, at this point, the tongue piece locking portion 44b of the tongue piece 44 of the locking component 40 is contacted and locked with the blocker sheet 22, thereby a motion of the lock sheet 20 is constrained. Furthermore, in this configuration, the first tongue piece state means that the tongue piece 44 is fixed in a specific position, is interfered with the blocker sheet 22, and constrains the lock sheet 20 from leaving the closed position. Furthermore, in one example, the moving position of the tongue piece 44 follows the moving piece 22, such that the tongue piece locking portion 44b is fixed in a position to be contacted and locked with the blocker sheet 22. In another example, the at least one first elastic element is connected between the tongue piece 44 and the lock base 10, such that the tongue piece locking portion 44b is fixed in a position to be contacted and locked with the blocker sheet 22.

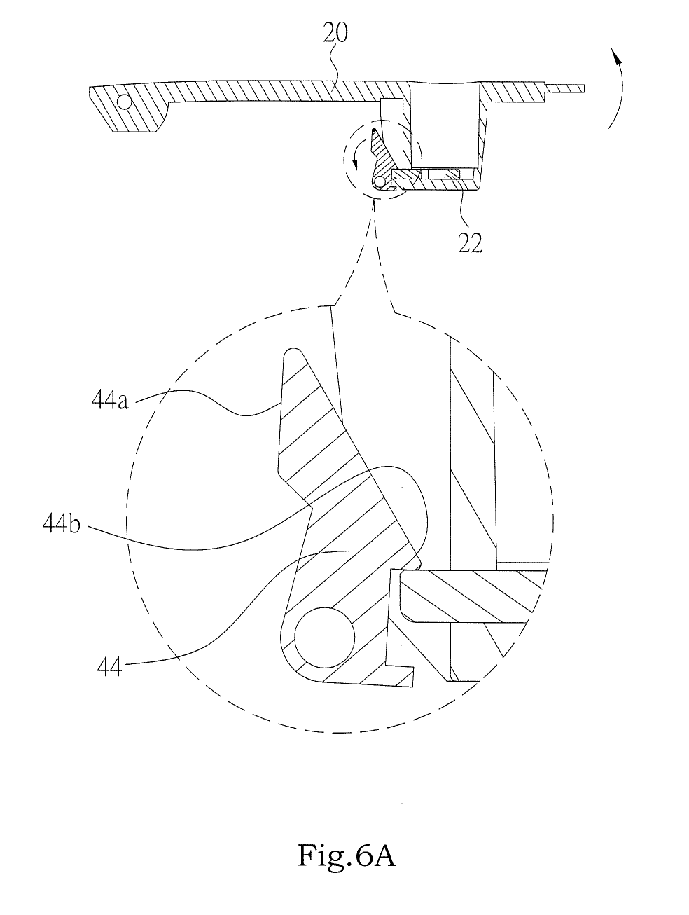

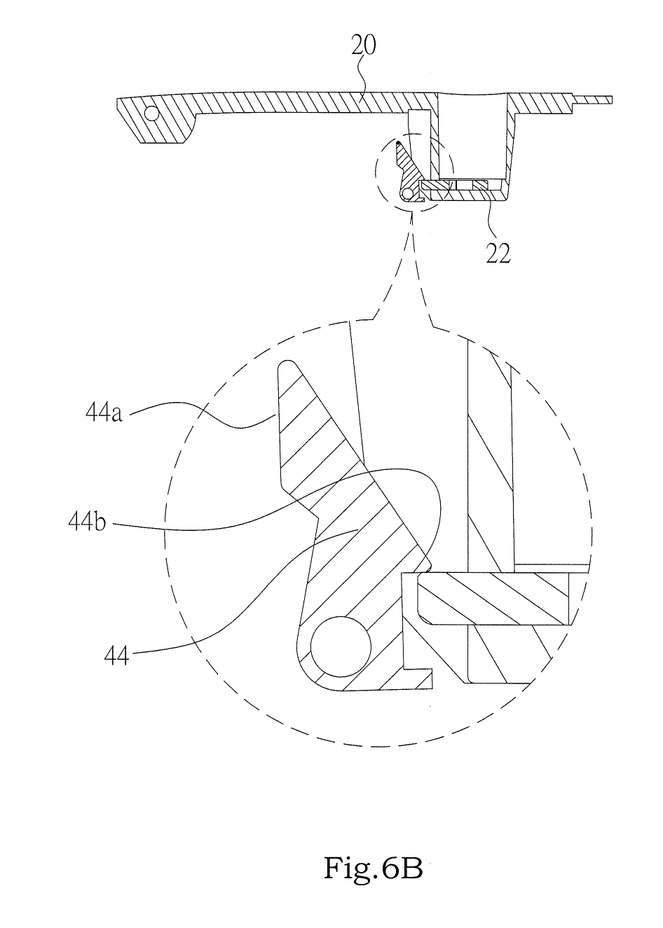

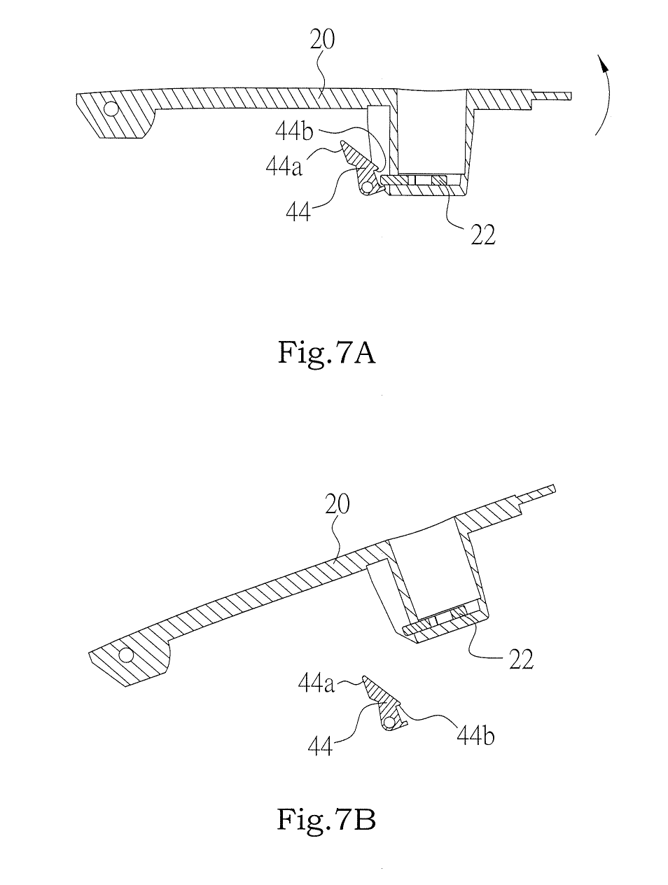

FIG. 6A and FIG. 6B shows an example that a motion of the lock sheet 20 is constrained by the locking component 40 and the locking component 40 will be moved with the lock sheet 20 according to FIG. 4A, which is different from the motion relation between the locking component 40 and the lock sheet 20 in FIG. 5. As shown in FIG. 6A, the lock sheet 20 is in the closed position, and the tongue piece locking portion 44b of the tongue piece 44 is contacted with the blocker sheet 22. When the lock sheet 20 is moved away from the closed position with respect to the lock base 10, i.e., from the position in FIG. 7A toward the position in FIG. 6B, the tongue piece locking portion 44b is pushed by the blocker sheet 22, such that the tongue piece 44 is moved. When the lock sheet 20 is moved to the position in FIG. 6B, the tongue piece 44 can not be pushed by the blocker sheet 22 and fixed in a specific position, such that the tongue piece locking portion 44b of the tongue piece 44 is interfered with the blocker sheet 22, thereby the lock sheet 20 is constrained from continuing to be moved in the direction away from the closed position with respect to the lock base 10. In addition, in this configuration, the first tongue piece state means that the tongue piece 44 is moved with the lock sheet 20 and has a first following range. In an extreme position of the first following range (as shown in FIG. 6B), the tongue piece 44 is interfered with the blocker sheet 22, and the lock sheet 20 is constrained from leaving the closed position.

Further referring to FIG. 7A and FIG. 7B, the example that the locking component 40 is not moved with the lock sheet 20 in FIG. 5 is continued, and a motion of the lock sheet 20 that is substantially not constrained by the locking component 40 is shown according to FIG. 4B. As shown in FIG. 7A, the lock sheet 20 is in the closed position (referring to FIG. 1), and the moving piece 34 is in the second moving position with respect to the lock base 10 (as shown in FIG. 4B). The lock sheet 20 is movable to an open position (as shown in FIG. 7B) if the lock sheet 20 is intended to be moved away from the closed position with respect to the lock base 10. That is, the lock sheet 20 may be out of the closed position. Preferably, the tongue piece 44 of the locking component 40 will not be interfered with the blocker sheet 22 if the lock sheet 20 is intended to be moved away from the closed position with respect to the lock base 10. In addition, in this configuration, the second tongue piece state means that the tongue piece 44 is fixed in a specific position and not interfered with the blocker sheet 22, and the lock sheet 20 may leave the closed position, i.e., the blocker sheet 22 is detached from the locking component 40.

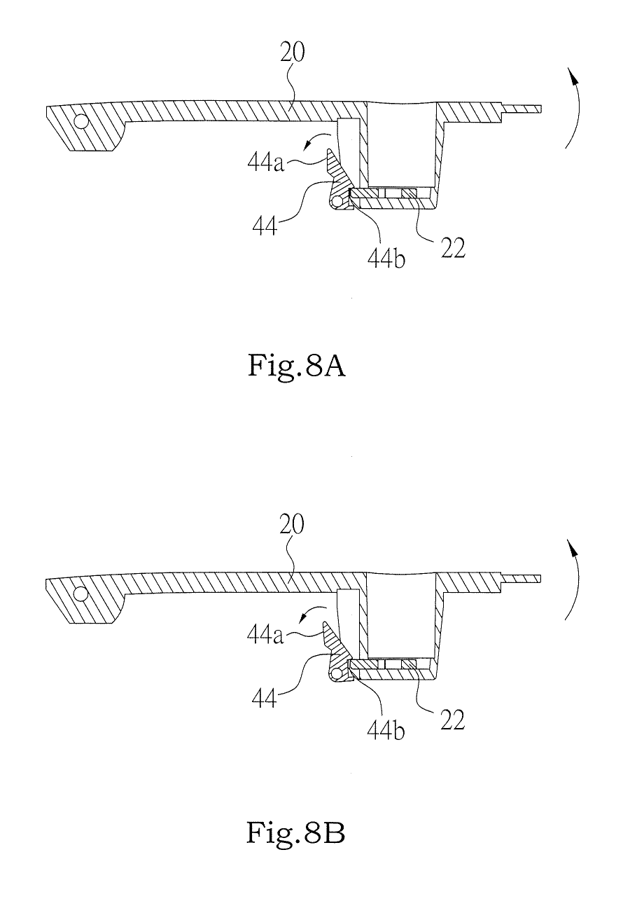

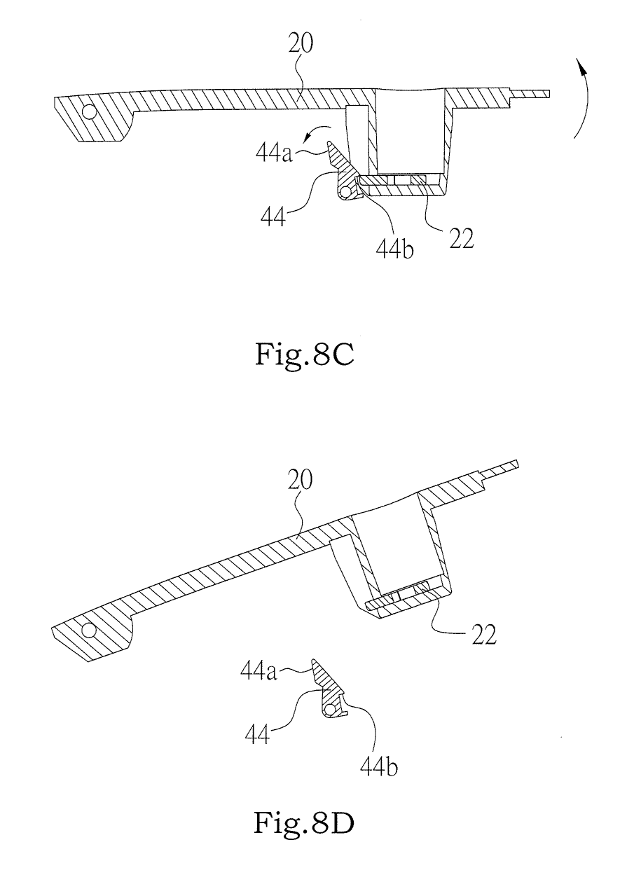

In another example, as shown in FIG. 8A to FIG. 8D, FIG. 8A to FIG. 8D are continued with the example that the locking component 40 is moved with the lock sheet 20 in FIG. 6A and

FIG. 6B, and a motion of the lock sheet 20 that is detachable from the locking component 40 is shown according to FIG. 4B. As shown in FIG. 8A, the lock sheet 20 is in the closed position (referring to FIG. 1), and the moving piece 34 is in the second moving position with respect to the lock base 10 (as shown in FIG. 4B). When the lock sheet 20 is intended to be moved away from the closed position with respect to the lock base 10, the tongue piece locking portion 44b is pushed by the blocker sheet 22, such that the tongue piece 44 is moved (as shown in FIG. 8B and FIG. 8C). When the lock sheet 20 is moved to the position in FIG. 8C, the tongue piece 44 is not pushed by the blocker sheet 22 any more and not interfered with the blocker sheet 22, thereby the lock sheet 20 may leave the closed position (as shown in FIG. 8D). In addition, in this configuration, the second tongue piece state means that the tongue piece 44 is moved with the lock sheet 20 and has a second following range. In an extreme position of the second following range (as shown in FIG. 8C), the tongue piece 44 will not be interfered with the blocker sheet 22, and the lock sheet 20 may leave the closed position, i.e., the blocker sheet 22 is detached from the locking component 40.

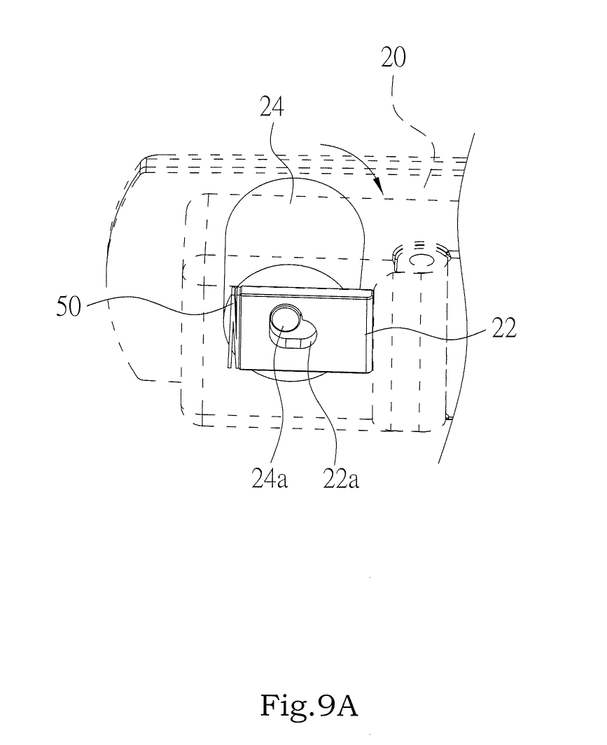

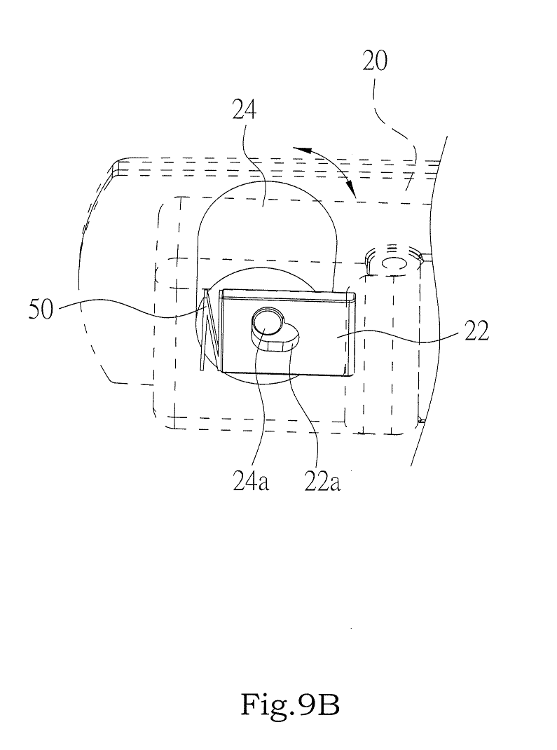

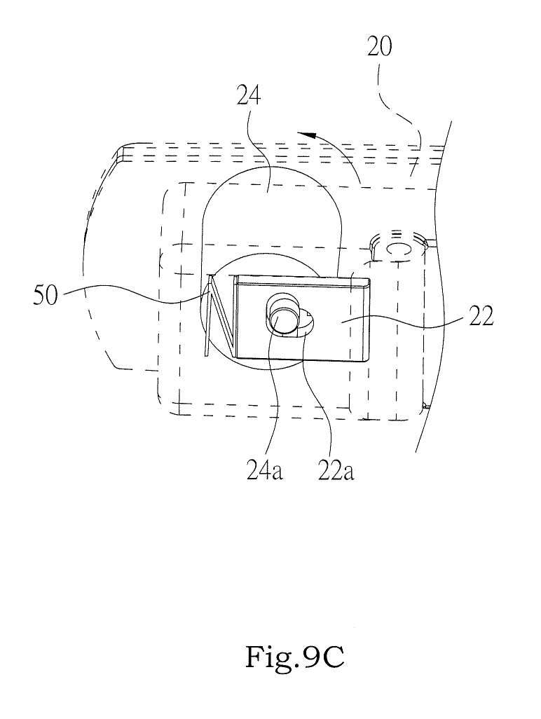

According to one embodiment of the present invention, FIG. 9A to FIG. 9C show that the blocker sheet 22 may be moved to an unlocked position, a preset position and a locked position with respect to the lock sheet 20 respectively, and the preset position is positioned between the locked position and the unlocked position. The lock sheet 20 further comprises a transmission piece 24, and the transmission piece 24 is movably connected between the lock sheet 20 and the blocker sheet 22. In more detail, the transmission piece 24 has a driving portion 24a, and the blocker sheet 22 has a follower portion 22a. The driving portion 24a is movably connected to the follower portion 22a, such that a motion of the transmission piece 24 with respect to the lock sheet 20 may drive the follower portion 22a through the driving portion 24a, and thus the blocker sheet 22 may be driven to be moved to the unlocked position, the preset position or the locked position with respect to the lock sheet 20. Moreover, it should be noted that the figures of the present invention only illustratively show that the transmission piece 24 is rotatably connected to the lock sheet 20, the blocker sheet 22 is slidably connected to the lock sheet 20, the driving portion 24a is an eccentric protrusive portion, the follower portion 22a is an indented portion having a particular shape, and the driving portion 24a and the follower portion 22a are connected through a cam pair/joint, such that the connection between the transmission piece 24 and the blocker sheet 22 has the above-mentioned motion relation. However, the connection manner between the transmission piece 24 and the blocker sheet 22 is not limited to this. In addition, when the blocker sheet 22 is in the preset position (as shown in FIG. 9B), the possible operating states of the lock assembly 1 are as mentioned above and as shown in FIG. 4A to FIG. 8B.

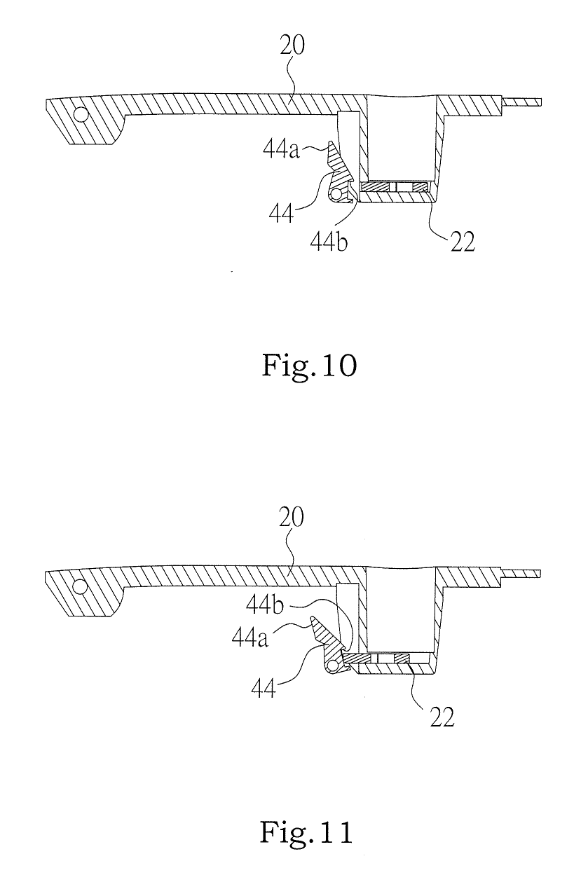

In addition, as shown in FIG. 9A and FIG. 10, when the blocker sheet 22 is in the unlocked position and the lock sheet 20 is in the closed position, even if the moving piece 34 is in the first moving position, with the retraction of the blocker sheet 22 toward the lock sheet 20 (compared to the position of the blocker sheet 22 in FIG. 9B), the lock sheet 20, during moving, may not cause the blocker sheet 22 and the tongue piece 44 to be interfered with each other, such that the lock sheet 20 may leave the closed position. Thus, the problem that the lock sheet 20 may not leave the closed position when the actuating component 30 fails and the moving piece 34 is in the first moving position can be solved. That is, when the blocker sheet 22 is in the unlocked position, the lock sheet 20 may leave the closed position at any time and without any restriction.

In addition, as shown in FIG. 9C and FIG. 11, when the blocker sheet 22 is in the locked position and the lock sheet 20 is in the closed position, even if the moving piece 34 is in the second moving position, with the stretch of the blocker sheet 22 away from the lock sheet 20 (compared to the position of the blocker sheet 22 in FIG. 9B), the lock sheet 20 that is intended to be moved away from the closed position with respect to the lock base 10 may be interfered with the tongue piece 44 and may not leave the closed position. Thus, the problem that the lock sheet 20 may not be constrained in the closed position when the actuating component 30 fails and the moving piece 34 is in the second moving position can be solved.

Referring to FIG. 9A to FIG. 9C again, in one preferred embodiment, the transmission piece 24 is disposed in the lock sheet 20 in a lock core configuration. Furthermore, the transmission piece 24 has an operating portion 24b, and the operating portion 24b has a lock hole (not shown). With the insertion of a key (not shown) corresponding to the lock hole into the lock hole, the transmission piece 24 may be driven to be moved with respect to the lock sheet 20, so that the blocker sheet 22 may be operated to be moved to the unlocked position, the preset position and the locked position with respect to the lock sheet 20. Moreover, various feasible specific structures and configurations of the lock core, the lock hole and the key mentioned above may be implemented by those skilled in the art, and thus are omitted herein. It should be noted that it is only an illustrative example that the transmission piece 24 may be driven by the cooperation of the lock hole and the key as mentioned above, and other means by which the transmission piece 24 may be driven is not excluded. Preferably, a second elastic element 50 is connected between the lock sheet 20 and the blocker sheet 22, so that when the blocker sheet 22 is moved with respect to the lock sheet 20, the second elastic element 50 has a second energy conversion between the potential energy and the kinetic energy, thereby the blocker sheet 22 has a tendency, caused by the second elastic element 50, to be toward a specific motion orientation.

What is claimed is:

1. A lock assembly structure, comprising:
a lock base;
an actuating component which is hydraulically or pneumatically driven and has a fixing piece and a moving piece, wherein the fixing piece is secured to the lock base, and the moving piece is movably connected to the fixing piece, such that the moving piece is movable with respect to the lock base and has a first moving position and a second moving position;
a locking component movably connected to the lock base, and when the moving piece is moved between the first moving position and the second moving position, the locking component is movably connected to the moving piece; and
a lock sheet movably connected to the lock base and having a blocker sheet, wherein the lock sheet is movable to a closed position and an open position with respect to the lock base;
wherein when the lock sheet is in the closed position and the moving piece is in the first moving position with respect to the lock base, the locking component is interfered with the blocker sheet if the lock sheet is intended to be moved away from the closed position with respect to the lock base, thereby a motion of the lock sheet with respect to the lock base is constrained;
wherein when the lock sheet is in the closed position and the moving piece is in the second moving position with respect to the lock base, the blocker sheet is detachable from the locking component if the lock sheet is intended to be moved away from the closed position with respect to the lock base, such that the lock sheet is movable to the open position.

2. The lock assembly structure according to claim 1, wherein the locking component is a tongue piece and the tongue piece has a tongue piece locking portion, wherein when the lock sheet is in the closed position and the moving piece is in the first moving position with respect to the lock base, the tongue piece locking portion is interfered with the blocker sheet if the lock sheet is intended to be moved away from the closed position with respect to the lock base, thereby a motion of the lock sheet with respect to the lock base is constrained, wherein when the lock sheet is in the closed position and the moving piece is in the second moving position with respect to the lock base, the blocker sheet is detachable from the tongue piece locking portion if the lock sheet is intended to be moved away from the closed position with respect to the lock base.

3. The lock assembly structure according to claim 1, wherein the locking component comprises a tongue piece and an intermediate piece, the tongue piece has a tongue piece contacting portion and a tongue piece locking portion, and the intermediate piece has a first contacting portion and a second contacting portion, wherein when the moving piece is moved between the first moving position and the second moving position, the first contacting portion is movably connected to the moving piece and the second contacting portion is movably connected to the tongue piece contacting portion, wherein when the lock sheet is in the closed position and the moving piece is in the first moving position with respect to the lock base, the tongue piece locking portion is interfered with the blocker sheet if the lock sheet is intended to be moved away from the closed position with respect to the lock base, thereby a motion of the lock sheet with respect to the lock base is constrained, wherein when the lock sheet is in the closed position and the moving piece is in the second moving position with respect to the lock base, the blocker sheet is detachable from the tongue piece locking portion if the lock sheet is intended to be moved away from the closed position with respect to the lock base.

4. The lock assembly structure according to claim 1, further comprising at least one first elastic element connected between the locking component and the lock base.

5. The lock assembly structure according to claim 1, wherein the fixing piece is connected to a fluid pipe, the fluid pipe has a valve element that is able to be opened and closed, and the moving piece is actuated to be moved with respect to the fixing piece through the opening or closing of the valve element.

6. The lock assembly structure according to claim 5, wherein the fixing piece and the moving piece of the actuating component are a cylinder and a piston rod respectively, and the moving piece is slidably connected to the fixing piece.

7. The lock assembly structure according to claim 1, wherein the blocker sheet is movably connected to the lock sheet and is movable to a preset position and an unlocked position with respect to the lock sheet, wherein when the lock sheet and the blocker sheet are in the closed position and the preset position respectively and the moving piece is in the first moving position with respect to the lock base, the locking component is interfered with the blocker sheet if the lock sheet is intended to be moved away from the closed position with respect to the lock base, thereby a motion of the lock sheet with respect to the lock base is constrained, wherein when the blocker sheet is in the unlocked position, the lock sheet is able to be out of the closed position.

8. The lock assembly structure according to claim 7, wherein the lock sheet further comprises a transmission piece, the transmission piece is movably connected between the lock sheet and the blocker sheet, and the blocker sheet is movable to the unlocked position and the preset position through a motion of the transmission piece.

9. The lock assembly structure according to claim 7, further comprising a second elastic element connected between the blocker sheet and the lock sheet.

10. The lock assembly structure according to claim 7, wherein the blocker sheet is further movable to a locked position with respect to the lock sheet, wherein when the lock sheet and the blocker sheet are in the closed position and the locked position respectively and the moving piece is in the second moving position with respect to the lock base, the locking component is interfered with the blocker sheet if the lock sheet is intended to be moved away from the closed position with respect to the lock base, thereby a motion of the lock sheet with respect to the lock base is constrained.

11. The lock assembly structure according to claim 2, wherein the blocker sheet is movably connected to the lock sheet and is movable to a preset position and an unlocked position with respect to the lock sheet, wherein when the lock sheet and the blocker sheet are in the closed position and the preset position respectively and the moving piece is in the first moving position with respect to the lock base, the locking component is interfered with the blocker sheet if the lock sheet is intended to be moved away from the closed position with respect to the lock base, thereby a motion of the lock sheet with respect to the lock base is constrained, wherein when the blocker sheet is in the unlocked position, the lock sheet is able to be out of the closed position.

12. The lock assembly structure according to claim 11, wherein the lock sheet further comprises a transmission piece, the transmission piece is movably connected between the lock sheet and the blocker sheet, and the blocker sheet is movable to the unlocked position and the preset position through a motion of the transmission piece.

13. The lock assembly structure according to claim 11, further comprising a second elastic element connected between the blocker sheet and the lock sheet.

14. The lock assembly structure according to claim 11, wherein the blocker sheet is further movable to a locked position with respect to the lock sheet, wherein when the lock sheet and the blocker sheet are in the closed position and the locked position respectively and the moving piece is in the second moving position with respect to the lock base, the locking component is interfered with the blocker sheet if the lock sheet is intended to be moved away from the closed position with respect to the lock base, thereby a motion of the lock sheet with respect to the lock base is constrained.

15. The lock assembly structure according to claim 3, wherein the blocker sheet is movably connected to the lock sheet and is movable to a preset position and an unlocked position with respect to the lock sheet, wherein when the lock sheet and the blocker sheet are in the closed position and the preset position respectively and the moving piece is in the first moving position with respect to the lock base, the locking component is interfered with the blocker sheet if the lock sheet is intended to be moved away from the closed position with respect to the lock base, thereby a motion of the lock sheet with respect to the lock base is constrained, wherein when the blocker sheet is in the unlocked position, the lock sheet is able to be out of the closed position.

16. The lock assembly structure according to claim 15, wherein the lock sheet further comprises a transmission piece, the transmission piece is movably connected between the lock sheet and the blocker sheet, and the blocker sheet is movable to the unlocked position and the preset position through a motion of the transmission piece.

17. The lock assembly structure according to claim 15, further comprising a second elastic element connected between the blocker sheet and the lock sheet.

18. The lock assembly structure according to claim 15, wherein the blocker sheet is further movable to a locked position with respect to the lock sheet, wherein when the lock sheet and the blocker sheet are in the closed position and the locked position respectively and the moving piece is in the second moving position with respect to the lock base, the locking component is interfered with the blocker sheet if the lock sheet is intended to be moved away from the closed position with respect to the lock base, thereby a motion of the lock sheet with respect to the lock base is constrained.
